(19) United States
(12) Patent Application Publication
(10) Pub. No.: US 2025/0353754 A1
(43) Pub. Date: Nov. 20, 2025

(54) Method to process borate by-products from sodium borohydride hydrolysis

(71) Applicants: UNIVERSIDADE DO PORTO, Porto (PT); LABORATÓRIO NACIONAL DE ENERGIA E GEOLOGIA, ALFRAGIDE (PT)

(72) Inventors: Alexandra Maria PINHEIRO DA SILVA FERREIRA RODRIGUES PINTO, Porto (PT); Diogo Luís ALMEIDA SILVA, Porto (PT); Hélder Xavier TEIXEIRA NUNES, Porto (PT); Lucas Ricardo CARDOSO MARCON, Port (PT); Cármen Mireya RANGEL ARCHILA, Lisboa (PT)

(73) Assignees: UNIVERSIDADE DO PORTO, Porto (PT); LABORATÓRIO NACIONAL DE ENERGIA E GEOLOGIA, ALFRAGIDE (PT)

(21) Appl. No.: 18/866,698

(22) PCT Filed: May 18, 2023
(86) PCT No.: PCT/IB2023/055129

§ 371 Date: Nov. 18, 2024

(30) Foreign Application Priority Data
May 18, 2022 (PT) 117987
Nov. 11, 2022 (PT) 118331

(51) Int. Cl. C01B 35/12; B01D 21/26; C01B 3/06; C01B 6/04

(52) U.S. Cl. CPC C01B 35/121; B01D 21/262; C01B 3/065; C01B 6/04; C01P 2002/72; C01P 2006/80

(57) ABSTRACT

The present disclosure relates to a method for processing a liquid by-product of sodium borohydride hydrolysis to obtain a borate compound, the method comprising the following steps: separating the liquid by-product by sedimentation, to obtain a borate-rich supernatant; drying the borate-rich supernatant under vacuum to obtain a solid composition comprising a borate compound. An aspect of the present disclosure relates composition obtainable by the disclosed method comprising at least 90% (w/w) of sodium boron hydroxide and its use as a source of borate in the production of sodium borohydride and/or hydrogen.

### TECHNICAL FIELD

The present disclosure relates to a method to process a by-product of sodium borohydride hydrolysis leading to the regeneration of NaBH₄ with economic potential, allowing its further re-hydrogenation.

### BACKGROUND

The hydrolysis of sodium borohydride for on-demand hydrogen generation has been studied as a clean alternative method to generate energy for portable and stationary devices, and additionally has a high potential as an off-grid solution. The process has relatively high hydrogen capacity (10.8 wt. %), releasing hydrogen with high purity at relatively low operational temperatures, producing environmentally benign by-products in a controllable reaction. One of its main disadvantages is the difficulty in obtaining a stable reaction by-product and further regenerating it back to sodium borohydride and closing the NaBH₄—H₂ cycle. Nevertheless, there has been little focus on its regeneration and even less on identification of the by-product effectively formed during the H₂ generation. This by-product can be formed in numerous hydration states, but since the main rehydrogenation methods studied only consider commercial borates, this has not been yet considered in the literature (Zhu et al. Angew. Chem. Int. Ed., 2020, 59, 8623-8629).

Indeed, the regeneration of sodium borohydride from its by-product is essential to close the NaBH₄—H₂ cycle and allow the viability of this method to generate H₂ as an energy carrier. However, the by-product formed on the NaBH₄ hydrolysis is not easily known and its stability is difficult to control. As listed in Table 1, the borate NaBO₂ is rehydrogenated with greater efficiency by thermo- and electrochemical processes. Mechanochemical processes are cleaner, and therefore these processes have been preferentially used to regenerate NaBH₄. As reported in the literature (Table 1) the mechanochemical processes are more efficient when the re-hydrogenated borate is NaB(OH)₄. Moreover, the by-product of the hydrolysis reaction of NaBH₄ is usually obtained in this form, thus not being necessary to apply dehydration methods before its rehydrogenation into NaBH₄. Furthermore, the composition of this by-product is quite unstable when extracted in an uncontrolled manner and may contain various compounds.

TABLE 1
Literature review on the efficiency of borate re-hydrogenation.

| | | | | Chemical | Efficiency | DOI |
|---|---|---|---|---|---|---|
| Method | Author | Borate | Hydration | Structure | % | reference |
| Mechano | Kong | NaBO₂ | — | NaBO₂ | 71.0 | 10.1021/ef900619y |
| | Çakanyildirim | Na₂B₄O₇ | — | Na₂B₄O₇ | 38.0 | 10.1080/ |
| | | | | | | 15567031003753579 |
| | Chen | NaBO₂ | 2 | NaB(OH)₄ | 89.8 | 10.1016/ |
| | | | | | | j.jpowsour.2017.05.075 |
| | Chen | NaBO₂ | 4 | NaB(OH)₄•2H₂O | 88.3 | 10.1016/ |
| | | | | | | j.jpowsour.2017.05.075 |
| | Chen | NaBO₂ | 2 and 4 | NaB(OH)₄ and | 82.0 | 10.1016/ |
| | | | | NaB(OH)₄•2H₂O | | j.jpowsour.2017.05.075 |
| Thermo | Kojima | NaBO₂ | — | NaBO₂ | 98.0 | 10.1016/S0360- |
| | | | | | | 3199(02)00173-8 |
| | Figen | NaBO₂ | — | NaBO₂ | 91.0 | 10.1016/ |
| | | | | | | j.ijhydene.2013.01.003 |
| Electro | Shu | NaBO₂ | — | NaBO₂ | 97.0 | 10.1016/ |
| | | | | | | j.fuel.2013.05.069 |

Document CN105271119 discloses preparation method for sodium borohydride, wherein Na₂B₄O₇ and NaOH are dissolved in water, a reaction is carried out at a temperature of 60° C.-80° C., and NaBO₂ is prepared; then a methanol solution and NaBO₂ are reacted at a temperature of 50° C.-90° C., and NaB(OCH₃)₄ is prepared; the obtained NaB(OCH₃)₄ is prepared into a THF and triethyl silicane solution, which is subjected to a synthetic reaction in an inert gas or vacuum environment, and the target product NaBH₄ is prepared. However, the disclosed method does not use a by-product of sodium borohydride hydrolysis, thus not closing the H₂ production circle.

Document JPH02208218 discloses a method to obtain high-purity sodium borohydride by reacting a specific trialkyl borate with sodium aluminum hydride. However, the disclosed method does not use a by-product of sodium borohydride hydrolysis, thus not closing the H₂ production circle.

These facts are disclosed in order to illustrate the technical problem addressed by the present disclosure.

### General Description

The present disclosure relates to a method to process a by-product compound, resulting from sodium borohydride hydrolysis, as soon as the hydrolysis reaction has been completed, to obtain the desired borate in the optimal structural form, which allows its regeneration to NaBH₄ in optimal cost-benefit conditions. After hydrolysis, the by-product can be extracted, separated from the catalyst by sedimentation and dried in a desiccator under vacuum for 6 to 8 days. Surprisingly, pure NaB(OH)₄ is obtained and ready to be rehydrogenated.

The disclosed method may result in a laboratory/industrial procedure, essential for the cost-effective regeneration of sodium borohydride. It can also be implemented in a NaBH₄—H₂ device for on-demand applications and off-grid hydrogen generation alternative solutions. It optimizes a green and safe H₂ generation process, further developing an essential step for its on-demand application: the by-product of reaction handling after the H₂ generation.

In an embodiment, the method presented has the ability to optimize the whole system by presenting an innovative process to handle the by-product formed upon sodium borohydride hydrolysis, leading to the obtention of a pure borate, i.e., borate with a purity of at least 90%. The processing of the borate by-product using the disclosed method reduces the time and cost required for its rehydrogenation and application in any possible NaBH₄—H₂ system.

The present disclosure relates to a method to obtain sodium borohydride from a liquid mixture comprising borate, the method comprising the following steps: separating the borate compound from the mixture by sedimentation; collecting the supernatant comprising the borate compound drying the borate compound, preferably in a desiccator under vacuum, to obtain a pure borate compound; and rehydrogenating the pure borate compound into sodium borohydride.

An aspect of the present disclosure relates to a method to obtain hydrogen comprising a step of obtaining sodium borohydride as described in the present disclosure.

In an embodiment, the method further comprises the following steps: adding a catalyst into a reactor; injecting a mixture of sodium borohydride and aqueous sodium hydroxide into the reactor; hydrolysing the sodium borohydride into hydrogen with formation of a liquid mixture comprising borate.

In an embodiment, the concentration of sodium hydroxide ranges from 0.5 to 70% (m/m), preferably from 0.7 to 10% (m/m), more preferably from 1 to 7% (m/m).

In an embodiment, the hydrogen generation and storage are obtained by injecting a NaBH₄ with NaOH aqueous solution in a stainless-steel batch reactor, using a metal catalyst. After hydrolysis, the application of the disclosed method assures the maximum conservation of the byproduct stability in the form of NaB(OH)₄, which is the best viable compound to be integrated in the rehydrogenation process (borate with higher cost-benefit).

In an embodiment, the hydrogen generation and storage are obtained by injecting a solution of 5-15 wt. % NaBH₄ with a 1-10 wt. % NaOH aqueous solution. Preferably, by injecting a solution of 10 wt. % NaBH₄ with a 7 wt. % NaOH aqueous solution.

In an embodiment, the NaBH₄ and NaOH aqueous solution are injected in a cylindrical reactor, preferably a cylindrical reactor with interior conical bottom.

In an embodiment, the hydrogen generation and storage are obtained by injecting a 10 wt. % NaBH₄ with 7 wt. % NaOH aqueous solution in a stainless-steel batch cylindrical reactor with interior conical bottom, using a Ni—Ru catalyst.

In an embodiment, the disclosed process comprises the extraction of a borate by-product in a liquid form, for example by using a pipette or other suction means, separation of the catalyst by sedimentation and drying under vacuum for 6 to 8 days. Pure or close to pure NaB(OH)₄ is obtained and prepared to be rehydrogenated. The obtained borate has great advantages for the rehydrogenation process, due to a lower energy demand by not requiring water evaporation, while also generating and storing pure H₂.

Surprisingly, the method described in the present disclosure results in a higher process efficiency, lower need of fresh NaBH₄, lower hydrogen cost and reduced economic and energetic costs.

The present disclosure also relates to a method for processing a liquid by-product of sodium borohydride hydrolysis to obtain a borate compound, the method comprising the following steps: separating the liquid by-product by sedimentation, to obtain a borate-rich supernatant; drying the borate-rich supernatant under vacuum to obtain a solid composition comprising a borate compound, wherein the borate compound is sodium boron hydroxide (NaB(OH)₄).

In an embodiment, the crystal form of the borate compound has an XRD pattern essentially the same as shown in FIG. 6B having a melting point ranging from 53° C. to 58° C.

In an embodiment, the solid composition comprises at least 90% (w/w) of the borate compound. In a further embodiment, the solid composition comprises at least 95% (w/w) of the borate compound.

In an embodiment, the borate-rich supernatant is dried under vacuum for 6 to 8 days.

In an embodiment, the method further comprises a step of rehydrogenating the borate compound into sodium borohydride.

In an embodiment, the rehydrogenation step is a thermochemical process, a mechanochemical process or an electrochemical process, preferably electrochemical.

In an embodiment, the sedimentation occurs by natural sedimentation, or by centrifugation. In a preferred embodiment, the sedimentation occurs for up to 12 hours, or the centrifugation occurs for up to 5 minutes.

An aspect of the present disclosure comprises a crystalline sodium boron hydroxide obtainable by the method described in any of the previous claims wherein the crystalline hydroxide form has an XRD pattern essentially the same as shown in FIG. 6B having a melting point ranging from 53° C. to 58° C.

In an embodiment, the crystalline sodium boron hydroxide comprises the absence of peaks at diffraction angles (2θ) of 21.4-21.6, 32.2-32-4 and 37.8-37.9 (FIG. 6B).

An aspect of the present disclosure comprises a composition obtainable by the disclosed method comprising at least 90% (w/w) of sodium boron hydroxide. In an embodiment, the composition obtainable by the disclosed method comprises at least 90% (w/w) of sodium boron hydroxide and up to 10% (w/w) of thermonatrite.

The present disclosure also relates to the use of the disclosed composition or crystalline sodium boron hydroxide as a source of borate in the production of sodium borohydride and/or hydrogen.

An aspect of the present disclosure comprises a method for obtaining hydrogen comprising a step of processing a liquid by-product of sodium borohydride hydrolysis as disclosed.

In an embodiment, the method for obtaining hydrogen further comprises the following steps: adding a catalyst into a reactor; injecting a mixture of sodium borohydride and aqueous sodium hydroxide into the reactor; hydrolysing the sodium borohydride into hydrogen with formation of a liquid by-product.

In an embodiment the catalyst is a metallic catalyst. In a preferred embodiment, the metallic catalyst is a bimetallic catalyst, preferably Ni—Ru.

In an embodiment the concentration of sodium borohydride ranges from 5 to 20% (w/w), preferably from 10 to 15% (w/w).

In an embodiment, the concentration of sodium hydroxide ranges from 0.5 to 70% (w/w), preferably from 0.7 to 10% (w/w), more preferably from 1 to 7% (m/m).

In an embodiment the mass ratio between sodium borohydride, sodium hydroxide and catalyst ranges from 10.0:7.0:4.0 to 10.0:7.0:6.3.

In an embodiment the hydrolysis step occurs at a temperature ranging from 18 to 27° C.

In an embodiment, the hydrolysis step starts at a pressure ranging from 60 to 102 kPa, preferably 101.325 kPa.

### BRIEF DESCRIPTION OF THE DRAWINGS

The following figures provide preferred embodiments for illustrating the disclosure and should not be seen as limiting the scope of invention.

FIG. 1: Schematic representation of an embodiment of a hydrogen synthesis method comprising the disclosed method to recover the borate by-product (1).

FIG. 2: Embodiment of the separation of the by-product by sedimentation of the catalyst.

FIG. 3: Embodiment of the by-product appearance after drying.

FIG. 4: Embodiment of results of by-product comparison (in mass %) between air exposure or vacuum drying.

FIG. 5: Embodiment of the hydrolysis' by-product composition (in mass %) under vacuum drying, for four different samples (numbered as 1,2,3 and 4).

FIG. 6: Embodiment of X-ray powder diffraction spectra for NaB(OH)₄ obtained by common drying process (“common drying”) or by the method described in the present disclosure (“present disclosure”).

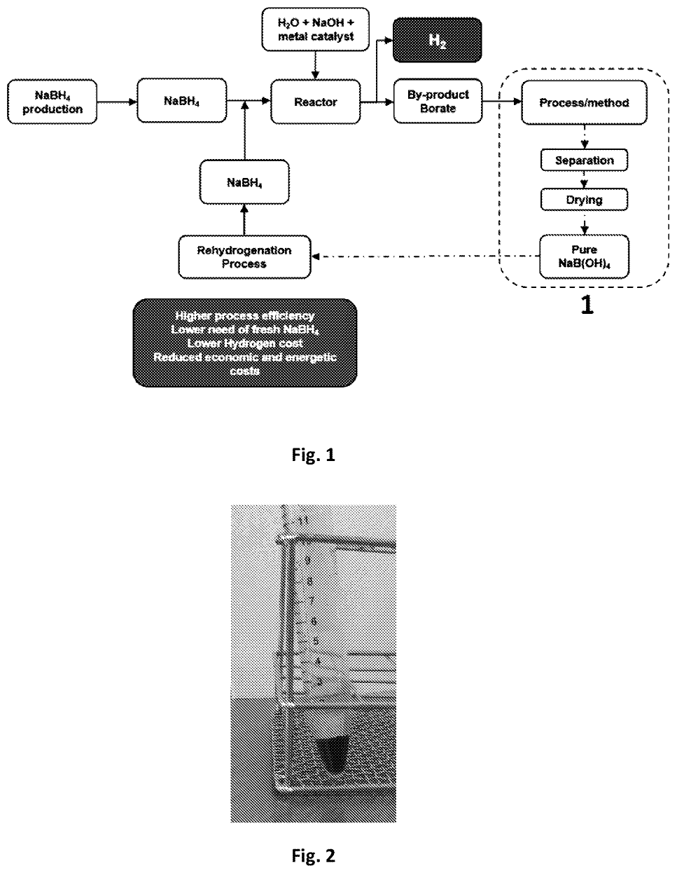

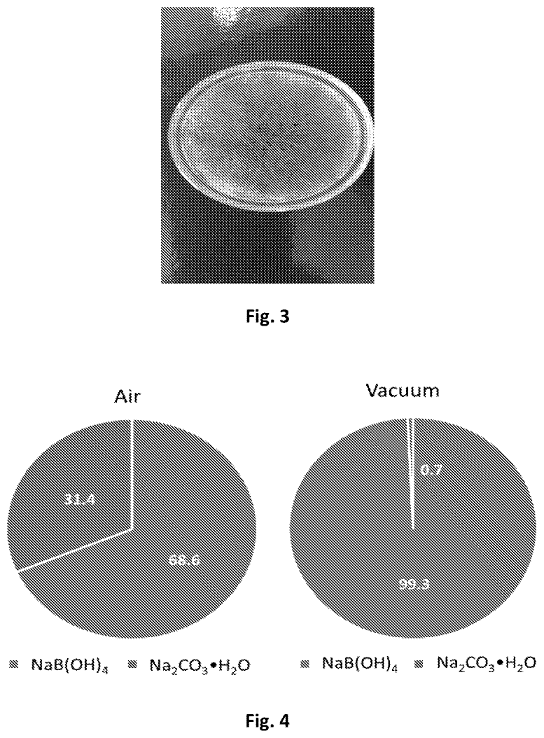

### DETAILED DESCRIPTION

The present disclosure relates to a method for processing a liquid by-product of sodium borohydride hydrolysis to obtain a borate compound, the method comprising the following steps: separating the liquid by-product by sedimentation, to obtain a borate-rich supernatant; drying the borate-rich supernatant under vacuum to obtain a solid composition comprising a borate compound, wherein the borate compound is sodium boron hydroxide.

The present disclosure relates to a method to obtain sodium borohydride from a liquid mixture comprising borate, the method comprising the following steps: separating the borate compound from the mixture by sedimentation; drying the borate compound to obtain a pure borate compound; and rehydrogenating the pure borate compound into sodium borohydride. An aspect of the present disclosure relates to a method to obtain hydrogen comprising the step of obtaining sodium borohydride from a liquid mixture comprising borate disclosed.

In an embodiment, NaBH₄ was used to produce hydrogen, in particular molecular hydrogen, via hydrolysis at room pressure and temperature.

For the scope and interpretation of the present disclosure, “room pressure” is defined as normal air pressure ranging from 60-102 kPa, preferably 101.325 kPa; and “room temperature” is defined as a temperature ranging from 15 to 27° C., preferably 18 to 25° C.

In an embodiment, a catalyst was used to obtain hydrogen from sodium borohydride, preferably a metallic catalyst, more preferably a bimetallic catalyst such Ni—Ru.

In an embodiment, 10% (m/m) of NaBH₄ was injected together with 7% (m/m) NaOH aqueous solution in a stainless-steel batch reactor, using 0.40-0.63 mass of catalyst per mass (mg) of sodium borohydride. After hydrolysis, the application of the disclosed method assures the maximum conservation of the byproduct stability in the form of NaB(OH)₄, which is the best viable compound to be integrated in the rehydrogenation process (borate with higher cost-benefit).

In an embodiment, the disclosed process comprises the extraction of a borate by-product in a liquid form following the production of H₂, separation of the catalyst used in H₂ production by natural sedimentation or forced sedimentation through centrifuge for up to 5 minutes, and drying the resulting supernatant under vacuum, preferably in an enclosed desiccator or similar equipment (for example a glove box) for 6 to 8 days. Pure or close to pure NaB(OH)₄ is obtained after drying, which is ready to be rehydrogenated. This is the best borate to rehydrogenate (lower energy demand by not requiring water evaporation) while also generating and storing pure H₂.

In an embodiment, the Ni—Ru catalyst can be reused. After sedimentation, the formed pellet can be collected and transferred to a glass beaker, washed, preferably at least three times, at room temperature and dried at 80° C. for 1 hour to be reused.

In an embodiment, the liquid by-product of reaction (supernatant resulting from sedimentation) is transferred to a container with a size adapted to the volume in consideration. For example, the container can be a glass petri dish. The container is then placed in an enclosed environment, e.g., a desiccator, under vacuum using a vacuum pump. For an average of 6 to 8 days the desiccator must remain closed during drying to avoid unnecessary contact with air. The by-product is dried when no liquid and only crystals are visible in the petri dish. As comparative example, the liquid by-product of reaction was also dried by air exposure at room temperature without any pressure control (no vacuum).

In an embodiment, X-ray powder diffraction (XRD) was used for phase identification of the obtained crystals. Briefly, this method allows the identification and quantification of the compounds present in a crystalline sample. Each compound reflects the x-rays that cross the sample in a different angle and intensity and, with the use of XRD databases, this compound can be identified. In an embodiment, the XRD patterns were recorded at room temperature using monochromatic Cu K-α radiation (λ=1.5406 Å). The range of the XRD patterns were 4°<20θ21 70°.

FIG. 4 shows an embodiment of results of by-product comparison (in mass %) between air exposure or vacuum drying, showing that the vacuum drying results in an higher mass percentage of NaB(OH)₄ (99.3%) than Na₂CO₃ (0.7%)), as compared to the results obtained with air drying (68.6% of NaB(OH) 4 and 31.4% of Na₂CO₃). FIG. 5 shows an embodiment of the hydrolysis' by-product composition (in mass %) under vacuum drying, for four different samples (numbered as 1,2,3 and 4).

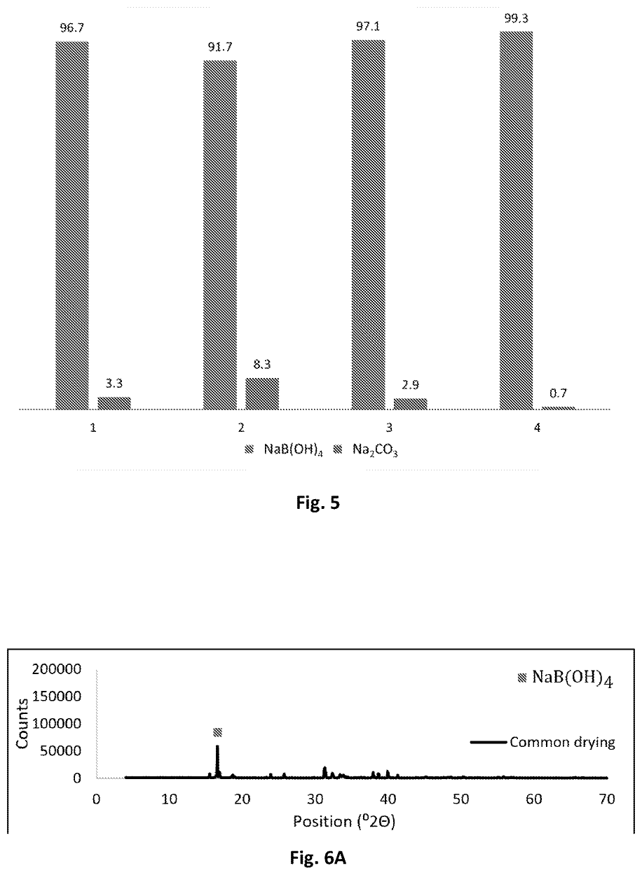

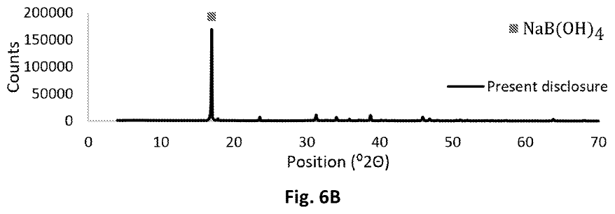

In an embodiment, the XRD analysis revealed that the crystalline sodium boron hydroxide obtained from the disclosed method comprises the absence of peaks at diffraction angles (2θ) of 21.4-21.6, 32.2-32-4 and 37.8-37.9 (FIG. 6B), which can be observed for the crystalline material obtained with common drying (FIG. 6A).

In an embodiment, after the vacuum drying, as described in the present disclosure, it is obtained a solid composition comprising at least 90% (w/w) of the borate compound, preferably NaB(OH)₄. This composition has great advantages for the process of rehydrogenation of sodium borohydride, and therefore its use on the production of hydrogen via sodium hydroxide hydrolysis, since it is a non-hydrated compound, thus not requiring dehydration upon rehydrogenation. Also, the obtained composition comprises at least 90% (w/w) of the borate compound, thus increasing the effectiveness of the rehydrogenation method by not giving rise to other unwanted compounds.

In an embodiment, crystals formed can be milled with a pestle and mortar to store the solid composition comprising the borate compound in powder. This step can be performed open to air, however minimal contact to air is preferred. When in no use, the solid composition comprising the borate compound can be stored in the same container, under vacuum.

In the state of the art, the regeneration of sodium borohydride may occur by different methods, such as thermochemical, mechano-chemical, or electrochemical processes. Thermochemical processes are based on reactions that involve high pressure and/or temperature; the mechano-chemical processes are similar to the thermochemical ones, but the source of energy used in this type of process relies on mechanical forces; the electrochemical processes use electric energy to produce sodium borohydride by reducing or oxidizing other borates.

After regeneration, the obtained sodium borohydride can be used on the production of hydrogen, via sodium borohydride hydrolysis, thus closing the NaBH₄—H₂ cycle.

The term “comprising” whenever used in this document is intended to indicate the presence of stated features, integers, steps, components, but not to preclude the presence or addition of one or more other features, integers, steps, components or groups thereof.

The disclosure should not be seen in any way restricted to the embodiments described and a person with ordinary skill in the art will foresee many possibilities to modifications thereof. The above described embodiments are combinable.

The following claims further set out particular embodiments of the disclosure.

1. A method for processing a liquid by-product of sodium borohydride hydrolysis to obtain a borate compound, the method comprising the following steps:
separating the liquid by-product by sedimentation, to obtain a borate-rich supernatant;
drying the borate-rich supernatant under vacuum to obtain a solid composition comprising a borate compound;
wherein the borate compound is sodium boron hydroxide (NaB(OH)₄).

2. The method according to claim 1, wherein the crystal form of the borate compound has an XRD pattern essentially the same as shown in FIG. 6B having a melting point ranging from 53° C. to 58° C.

3. The method according to claim 1, wherein the solid composition comprises at least 90% (w/w) of the borate compound (NaB(OH)₄).

4. (canceled)

5. The method according to claim 1, wherein the borate-rich supernatant is dried under vacuum for 6 to 8 days.

6. The method according to claim 1, further comprising a step of rehydrogenating the borate compound into sodium borohydride.

7. The method according to claim 6, wherein the rehydrogenation step is a thermochemical process, a mechanochemical process or an electrochemical process, preferably electrochemical.

8. The method according to claim 1, wherein the sedimentation occurs by natural sedimentation, or by centrifugation.

9. The method according to claim 8, wherein the sedimentation occurs for up to 12 hours, or the centrifugation occurs for up to 5 minutes.

10. A crystalline sodium boron hydroxide (NaB(OH)₄) obtainable by the method of claim 6, wherein the crystalline hydroxide form has an XRD pattern essentially the same as shown in FIG. 6B having a melting point ranging from 53° C. to 58° C.

11. The crystalline sodium boron hydroxide (NaB(OH)₄) according to claim 10 comprising the absence of peaks at diffraction angles (2θ) of 21.4-21.6, 32.2-32.4 and 37.8-37.9.

12. A composition obtainable by the method described in claim 1 comprising at least 90% (w/w) of sodium boron hydroxide (NaB(OH)₄), and thermonatrite.

13. A method for production of sodium boron hydroxide (NaB(OH)₄) and/or hydrogen comprising using a composition as described in claim 12 as a source of borate in the production of sodium borohydride and/or hydrogen.

14. A method for obtaining hydrogen comprising a step of processing a liquid by-product of sodium borohydride hydrolysis as described in claim 1.

15. The method according to claim 14 further comprising the following steps:
adding a catalyst into a reactor;
injecting a mixture of sodium borohydride and aqueous sodium hydroxide into the reactor;
hydrolysing the sodium borohydride into hydrogen with formation of a liquid by-product.

16. The method according to claim 14, wherein the catalyst is a metallic catalyst, preferably wherein the metallic catalyst is a bimetallic catalyst, more preferably Ni—Ru.

17. (canceled)

18. The method according to claim 14, wherein the concentration of sodium borohydride ranges from 5 to 20% (w/w), preferably from 10 to 15% (w/w).

19. The method according to claim 14, wherein the concentration of sodium hydroxide ranges from 0.5 to 70% (w/w).

20. The method according to claim 14, wherein the mass ratio between sodium borohydride, sodium hydroxide and catalyst ranges from 10.0:7.0:4.0 to 10.0:7.0:6.3.

21. The method according to claim 14 wherein the hydrolysis step occurs at a temperature ranging from 18 to 27° C.

22. The method according to claim 14, wherein the hydrolysis step starts at a pressure ranging from 60 to 102 kPa.
